(19) United States
(12) Patent Application Publication
(10) Pub. No.: US 2013/0104041 A1
(43) Pub. Date: Apr. 25, 2013

(54) Capturing application workflow

(71) Applicants: Nandagopal Seshagiri, Singapore (SG); Mohit Chugh, San Francisco, CA (US); Toby Patrick Francis Rahilly, Singapore (SG)

(72) Inventors: Nandagopal Seshagiri, Singapore (SG); Mohit Chugh, San Francisco, CA (US); Toby Patrick Francis Rahilly, Singapore (SG)

(73) Assignee: INTERNATIONAL BUSINESS MACHINES CORPORATION, Armonk, NY (US)

(21) Appl. No.: 13/278,400

(22) Filed: Oct. 21, 2011

(51) Int. Cl. G06F 3/01

(52) U.S. Cl. 715/704

(57) ABSTRACT

An application workflow capture system records application usage and behavior semantically as a series of XML-based “events.” A capture tool is used to capture a target application workflow, and a replay tool is used to replay the captured data. The capture tool generates a workflow capture file that includes a set of information about a user's interaction with the application. When it is desired to analyze the application, the file is then provided to the replay tool. The replay tool consumes the workflow capture file and, based on the information therein, generates an executable. When launched by a player, the executable reads the captured workflow from the file and performs changes in the application properties and user inputs, preferably in the same order which they occur in the captured workflow. The behavior of the executable mimics that of the target application.

### BACKGROUND OF THE INVENTION

1. Technical Field

This disclosure relates generally to techniques for capturing user interaction with software application workflow to facilitate application development, testing, auditing, support and error reporting.

2. Background of the Related Art

Single sign-on (SSO) is an access control mechanism which enables a user to authenticate once (e.g., by providing a user name and password) and gain access to software resources across multiple systems. Typically, an SSO application enables user access to resources within an enterprise or an organization.

Enabling an SSO function within an enterprise often is a complex design and/or implementation problem. Often, the SSO functionality is developed by an entity external to the enterprise. Before an SSO application can be developed and implemented across an enterprise, typically it is desirable to capture (for analysis purposes) detailed information about login, password change and logout workflows, as well as mechanisms to identify uniquely those portions of the application user interface (UI) (e.g., window titles, displayed text in mainframe applications, identifiers in HTML, and the like) that participate in these workflows. Gathering all of this information requires access to the application itself, as well as access to the credentials that may be used to explore the various workflows and to test the SSO functionality. A substantial cause of delay in any SSO/UI automation roll-out is obtaining access to the organization's internal applications. Many organizations disallow remote access to their internal applications, often resulting in time-consuming and costly physical visits to a client location to facilitate the development and testing work. Even in those situations where access to the application is possible, it is difficult to obtain valid credentials to enable the exploration and testing that are required of the application.

There are other scenarios where it is desired to capture a user's interaction with an application. As another example, it is often desirable to analyze the behavior or usage of a software application after the occurrence itself. A use case for such analysis includes auditing of a user's behavior in the application and their use of associated systems. Another common use case involves error reporting, where support teams desire to obtain access to the behavior of an application that is being analyzed.

It is known in the prior art to provide tools that can capture and create user profiles. One such tool is available as a component of the IBM® Tivoli® Access Manager for Enterprise Single Sign-On solution. This tool, called AccessStudio, includes a profile creator that selects an application window to capture its properties that would be used in an access profile.

It is also well-known to record an application session using video. While such approaches facilitate later inspective of application usage, such techniques typically are limited in that they do not allow for searching, data analysis, interaction, annotation or manual modification of an existing recording. In addition, videos are difficult to manage from a storage perspective, and it is very difficult to remove sensitive information (e.g., passwords, personal details, and the like) from such recordings. Removal of such information is often a requirement before external support can be implemented.

There remains a need in the art to provide new techniques for capturing application workflow that addresses these and other deficiencies in the known art.

### BRIEF SUMMARY

This disclosure describes a technique and system to record application usage and behavior semantically as a series of one or more “events” that are managed as text. To this end, a system preferably includes a capturing tool that is used to capture a target application workflow, and a replay tool is used to replay the captured data. In one embodiment, the capturing tool is executed in an off-line manner and installs an event listener software module in the target application. The module monitors the application as a user interacts with the target application. The capture tool generates a workflow capture file (a data record) that includes a set of information about the user-target application interaction. The information typically includes application properties (e.g., executable name, main window title, window styles, and the like), the user's interaction with the application (preferably in the form of a time-stamped sequence of events), and any changes in the application properties (e.g., new window openings). Once the workflow is captured, the workflow capture file is saved. When it is desired to analyze the application, the file is then provided to the replay tool. The replay tool consumes the workflow capture file and, based on the information therein, generates an executable. When launched by a player (or other playback application), the executable reads the captured workflow from the file and performs changes in the application properties and user inputs (such as creating windows and displaying text), preferably in the same order which they occur in the captured workflow. As the executable performs the same property changes and receives the same simulated user input as the original application, the behavior of the executable mimics that of the original target application. As such, the simulated workflow can be used to observe the target application's behavior, which is useful for development (including, without limitation, SSO enablement), testing, auditing, support and related activities.

Preferably, in addition to performing the captured workflow, the executable presents interface controls that allow the user of the replay tool to specify the timing of the workflow. Thus, for example, the user can slow or speed up time, perform individual steps one at a time, skip forwards or backwards to different parts of the workflow, and so forth. If desired, any sensitive information captured by the capturing tool may be redacted or removed prior to playback.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a known enterprise single sign-on system;

FIG. 4 depicts a block diagram of an application workflow capture system according to this disclosure;

FIG. 5 depicts a block diagram of the event listener software module of the application workflow capture system;

FIG. 6 depicts a block diagram of the player tool of the application workflow capture system;

FIG. 7 depicts a first workflow example illustrating how the event listener module is used to capture events from a mainframe application;

FIG. 8 depicts a second workflow example illustrating how the event listener module is used to capture events from a windows-based application; and

FIG. 9 depicts a portion of a recording generated by the described technique.

### DETAILED DESCRIPTION OF AN ILLUSTRATIVE EMBODIMENT

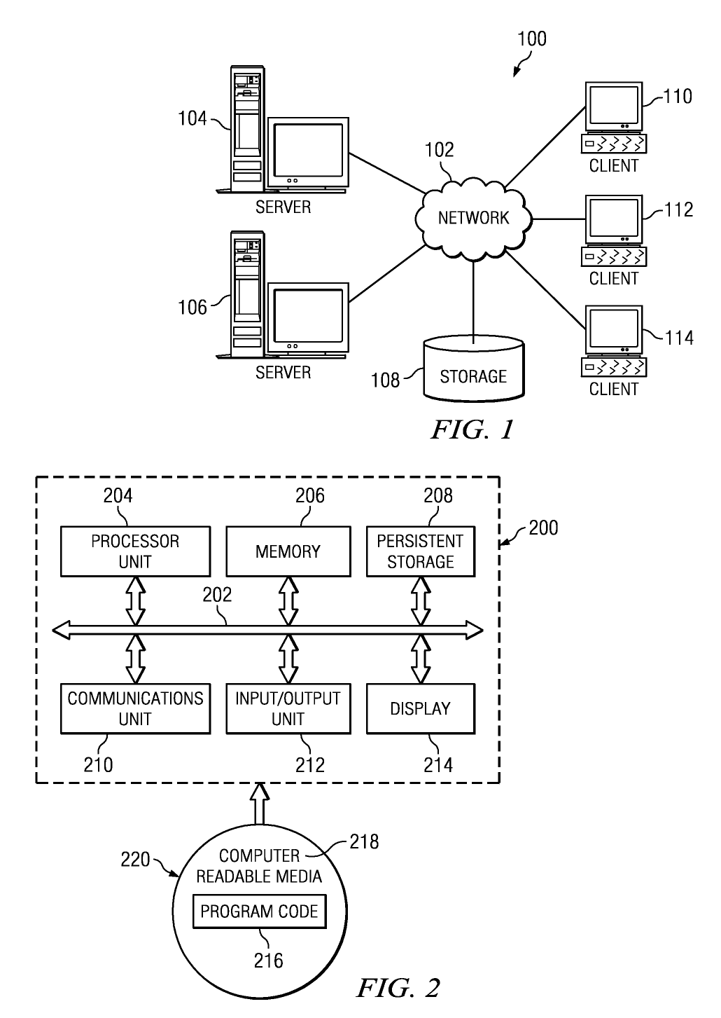

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

### The Client-Server Model

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. In such an approach, end users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

In the alternative, the techniques described herein may operate within a standalone data processing system, or within the context of a “cloud” environment wherein computing resources are shared among a number of entities.

### Enterprise SSO

Single sign-on (SSO) is an access control mechanism which enables a user to authenticate once (e.g., by providing a user name and password) and gain access to software resources across multiple systems. Typically, an SSO system enables user access to resources within an enterprise or an organization.

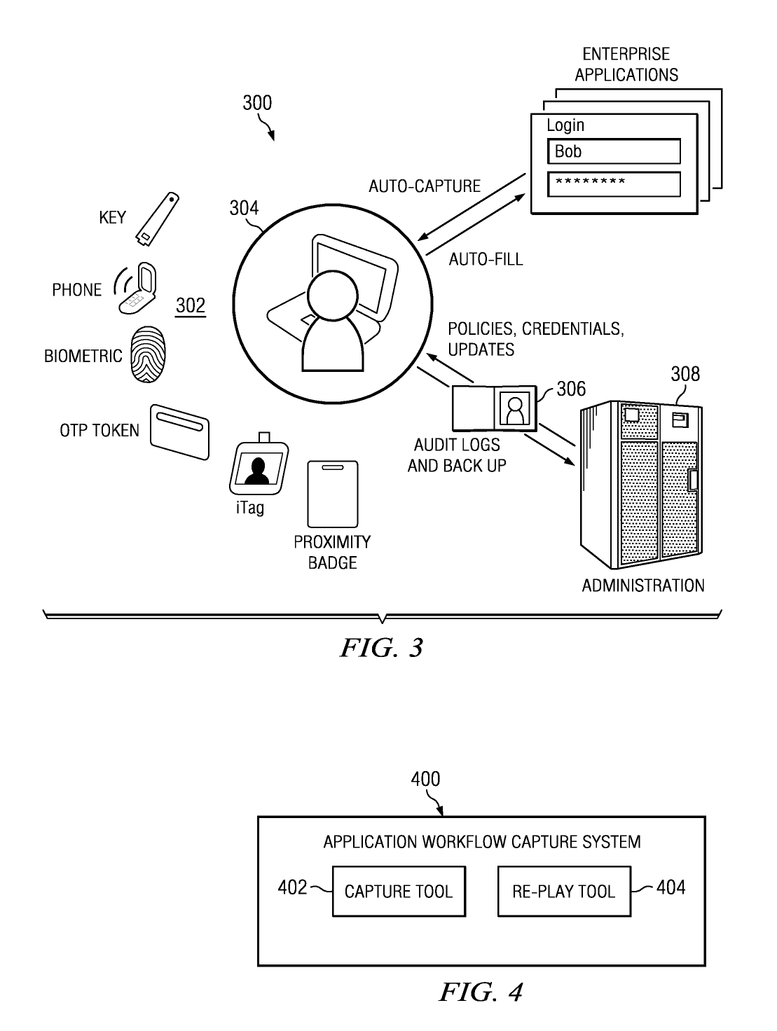

By way of further background, FIG. 3 illustrates a known system 300 for enterprise single sign-on (ESSO). Using this system, enterprise employees authenticate once, and the system then detects and automates all password-related events for the employee, including: logon, password selection, password change, password reset, automated navigation to any screen in the an application where productive work can begin, and logoff. Preferably, the system 300 supports an open authentication device interface 302 to facilitate operation with a variety of authentication “factors” including, without limitation, USB smart token, phone, biometric, one-time password token, RFID badge, and smart card. To facilitate the SSO operation, an access agent 304 acts on the user's behalf for single sign-on and sign-off, authentication management and session management. The access agent 304 typically executes in an end user client machine and in association with a client application or web browser. Plug-ins enable the access agent behavior to be customized. An identity wallet 306 is a personal, encrypted repository of user credentials for each user. The identity wallet 306 roams to a given point of access and stores the user's personal identity profiles including log-in credentials, certificates, encryption keys and user policies. The integrated management system (IMS) server 308 provides centralized management of users and policies. Preferably, polices are defined centrally and enforced through the access agent. The server 308 may also provide credential backup, loss management, audit information, and compliance reporting. A representative system of this type is available commercially as IBM® Tivoli® Access Manager for Enterprise Single Sign-On.

The enterprise SSO system such as described above works by maintaining in the identity wallet passwords to the enterprise applications a user uses within the enterprise. The user logs into the SSO system. When a user opens an application, the SSO system fetches (from the wallet) the password corresponding to that application, injects the password into the application, and logs-in the user. The act of injection requires intimate knowledge about the user interface of the application itself, and it is these details that must be taken into consideration in designing an SSO workflow.

### Capturing Application Workflow

With the above background, the subject matter of this disclosure describes an application workflow system to record application usage and behavior semantically as a series of one or more “events” that are managed as text. In several embodiments described herein, the application of interest (sometimes referred to as the “target” application) includes SSO functionality and, thus, is said to be “SSO enabled.” The example of an SSO application is not a limitation of the disclosed technique, however, as the application workflow capture technique and system may be used with any target application regardless of its purpose.

FIG. 4 illustrates a representative embodiment of an application workflow capture system 400 of this disclosure. The system comprises two (2) basic tools, a capture tool 402, and a re-play tool 404. Tools 402 and 404 may be integrated; thus, the designation of two separate tools is merely for illustration. Alternatively, each tool may be a separate functionality. Typically, each such tool (and thus the system) is implemented in computer software executing on one or more processors or processing devices. Depending on implementation, the computer software typically comprises one or more computer programs, one or more processes, one or more execution threads, etc., and associated data and data structures. The programs and data are held in computer memory. FIG. 5 depicts the capture tool in more detail. As illustrated, the capture tool preferably is implemented as an “event listener software module” 500 that is injected into the target application 502. The module typically comprises two (2) components: window hook code 504, and application programming interface (API) hijack code 506. The window hook code 504 monitors Microsoft® Windows operating system (OS) hooks to capture one or more “events” that occur inside the target application and that are desired to be recorded. These events include, without limitation, window creation, activation and destruction, keyboard and mouse inputs, and the like. Because it is not possible to monitor for text outputs that happen on a window, the API hijack code 506 is used to monitor for Window OS system calls that are made to output text. The hook code 504 and the API hijack code 506 work together to capture each pertinent event along with its details so that the event can be reproduced during playback.

The events record the behavior of different user interface elements of the target application along with the user input. Thus, for example, the hook code may capture information about a window generally, as well as information about each window control (button, checkbox, dropdown list entry, etc.) therein, including the window control's insertion onto the display screen along with its location. Each such activity may be captured as a distinct “event.” Likewise, the API code can capture as an event text as it is being printed to a terminal application window. In such case, the event parameters might include the text printed and the location of the window. By capturing such information in such fine-grained detail, a “simulation” of the target application workflow can be re-generated, analyzed, studied, interacted with, and the like.

All window hook and OS/API events may be captured, or only certain of such events may be captured. The capture tool may be configured (automatically, programmatically, or manually) depending on the target application and the purposes for which the data is being captured. If desired, the capture tool is configured to filter out (mask) certain sensitive information, such as user identifiers, passwords, or other private information, that comprises event data. Of course, the event capture technique is not limited for use with Windows-based operating systems. In an operating system based on Linux, for example, XServer API may be used to capture application events.

Thus, according to this disclosure, and using window-based hooks and/or API monitoring (or their equivalents), the event listener module captures details of one or more (and preferably all) relevant events that happen inside the target application. The details of each event along with an event identifier and timestamp are logged into an application workflow capture file as they occur. The workflow capture file (or, more generally, a data record) includes a set of information about the user-target application interaction. Preferably, the information is encoded as eXtensible Markup Language (XML), although this is not a limitation, as other text-based formats may be used. The information typically includes, without limitation, application properties (e.g., executable name, main window title, window styles, and the like), the user's interaction with the application (preferably in the form of a time-stamped sequence of events), and any changes in the application properties (e.g., new window openings).

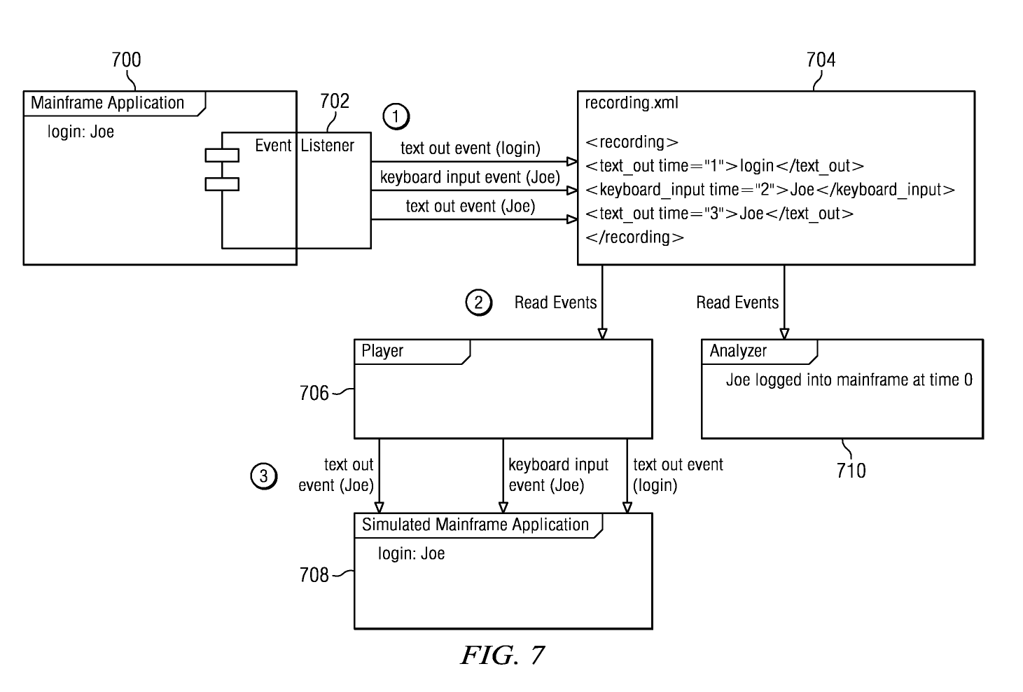

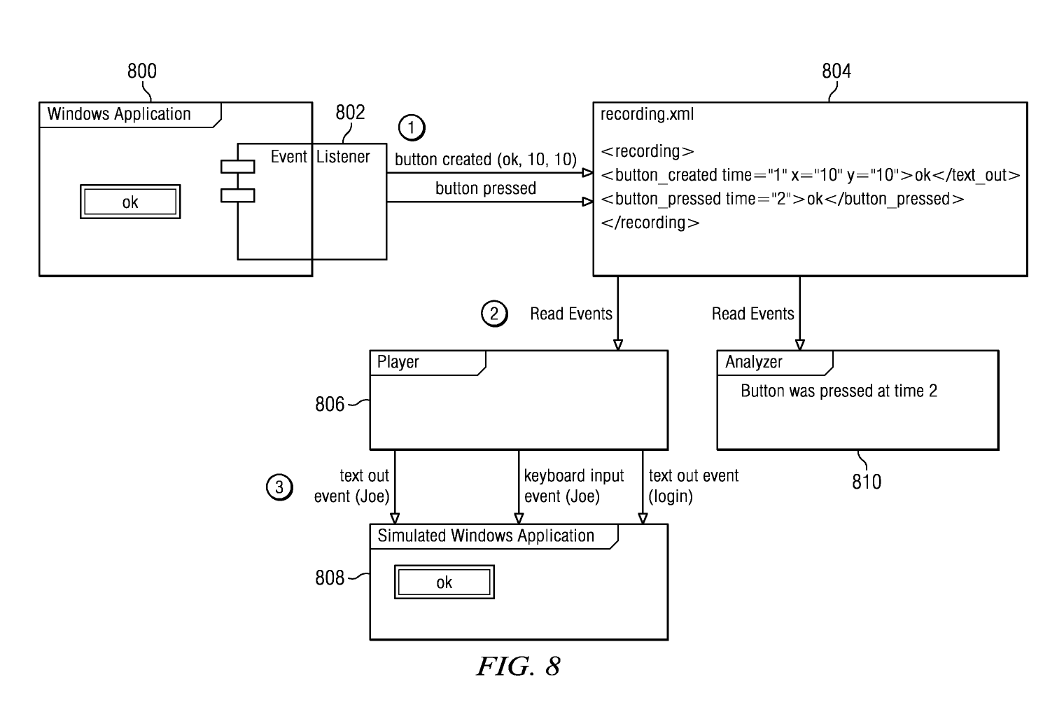

FIG. 7 illustrates this recording process for a mainframe target application, and FIG. 8 illustrates this recording process for a typical windows-based target application. As seen in FIG. 7, mainframe application 700 has been injected with the event listener 702, which at step 1, generates a number of different events relating to an attempt (by user Joe) to login to the application. The events are written to an application capture workflow file 704, preferably in the form of an XML file. The XML statements in the file evidence application usage and user behavior semantically, preferably as a series of text statements. As will be described in more detail below, at step 2 the application capture workflow file 704 may be provided to a player application 706, which (at step 3) utilizes the file (as an executable) to re-play the application as a “simulated” mainframe application 708. In addition, the workflow file 704 may be provided (at step 4) to an analyzer component 710 that logs the action. FIG. 8 illustrates a similar operation for a Windows application 800 into which the event listener 802 has been injected. As described above, the event listener functions to record the events as user Joe performs a particular user interface interaction with a window. At step 1, these events are recorded in the workflow file 804 and (at step 2) made available to the player 806, which can then render (at step 3) the “simulated” Windows application 808, and/or to the analyzer component 810 that (at step 4) logs the action.

As can be seen, the technique captures the structural representation of both the actual user interface elements (e.g., window titles, button labels, user interface object identifiers, and the like), together with the particular user actions (e.g., mouse clicks, keyboard entry, hand gestures, and the like) with respect to those user interface elements. The information is captured semantically and saved in a compact manner, perhaps with additional system- or user-supplied information. The display screens and windows are then re-created with the same structure and user interactions as captured from the real application. The replay tool then creates the mimicked application and executes the replay on it.

Although not meant to be limited, in a typical use case, the event listener module is injected into the target application and executed by an entity responsible for the target application. The application capture workflow file may then be delivered to another entity that is responsible for the player application and/or the analyzer component. This approach is useful when the original target application is not available to, or accessible by, the entity that executes that capture tool. In another alternative, the player application and/or the analyzer component may be operated as a “service” on behalf of entities that embed the event listener module in one or more target applications. There is no requirement that the event listener (and thus the target application) be co-located with the player application and/or analyzer component.

In addition, the event listener module need not be injected into the target application but may run as an adjunct to the target application. Instead of being written to XML at the point of capture, the events may be captured and then transmitted (e.g., over a network protocol) to a remote location, where they may then be written into the workflow file.

Because XML (or other machine-readable language) is preferred for use, any XML-based request-response transport mechanism may be used to transport the event data from the event listener to the workflow file. In another alternative, the XML file may be captured and provided to another entity using any conventional delivery means, such as e-mail, text messaging, file transfer, or the like.

The event listener module may be injected dynamically (on-the-fly) as the capture tool is run, or the necessary interception hooks may be linked to (or otherwise embedded in) the target application statically. A particular target application may be written in the first instance to include the hook code.

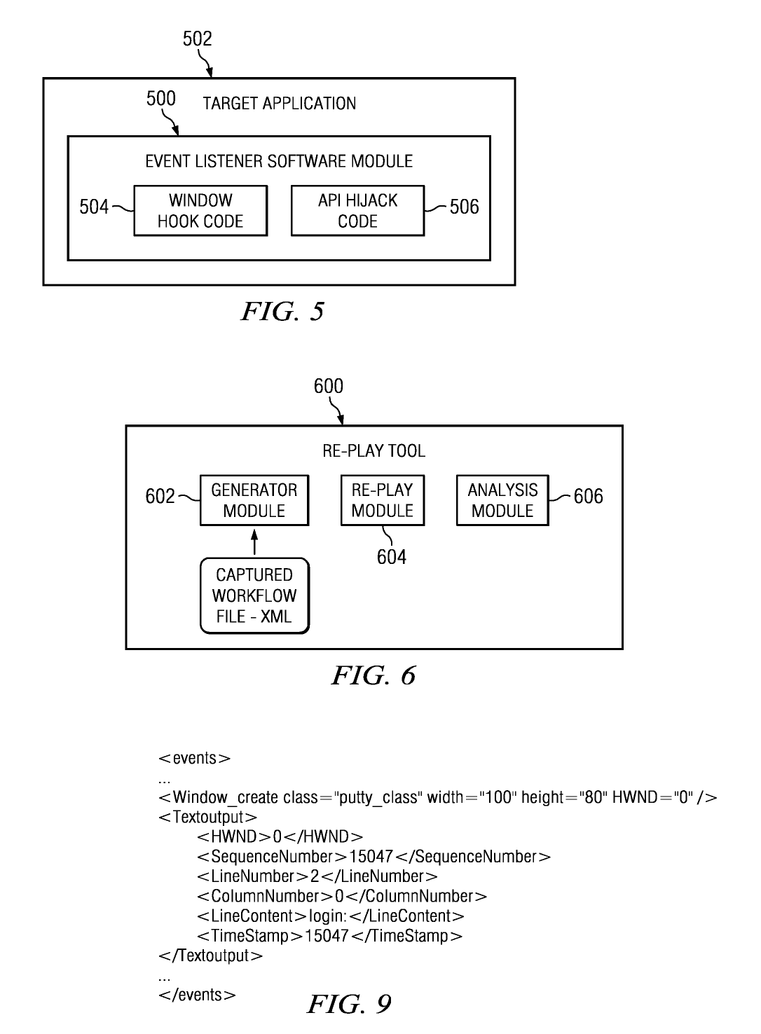

FIG. 6 illustrates a representative replay tool 600 that is used to replay the captured data. The replay tool typically comprises a generator module 602, a player module 604, and an analysis module 606. The player module and the analysis module were described above in the examples shown in FIG. 7, and in FIG. 8. The generator module 602 consumes the XML-based workflow capture file and, based on the information therein, generates an executable 603. When launched by the player module 604 (or other playback application), the executable 603 reads the captured workflow from the file and creates a clone of the application that is substantially indistinguishable from the application. In particular, as the executable is run by the player module 604, the simulated application executes (in the data processing system in which the replay tool is running). The application properties and user inputs are then re-played, preferably in the same order which they occur in the captured workflow. As the executable performs the same property changes and receives the same simulated user input as the original application, the behavior of the executable mimics that of the original target application. As such, the simulated workflow can be used to observe the target application's behavior.

The generator module as shown in FIG. 6 is not required. In the alternative, the XML may be parsed directly and used to create the mimicked application. In such case, the player may include or have access to an XML parser.

In addition to performing the captured workflow, preferably the executable presents a set of interface controls that allow the user of the replay tool to specify the timing of the workflow. These interface controls may be rendered in any convenient manner, such as by an overlay display that includes a stop button, a reverse button, a fast forward button, a jump button, and the like. The overlay display may also include other playback controls as necessary to enable control over the playback. Using such controls, the user can walk through the events, one-by-one, skip-over certain events (or event types), go forwards or backwards in time, and so forth. The user controls may be configured in any convenient manner. Thus, for example, the user can slow or speed up time, perform individual steps one at a time, skip forwards or backwards to different parts of the workflow, and so forth. If desired, any sensitive information captured by the capturing tool may be redacted or removed prior to playback. In the alternative, the replay tool may be programmed to redact or otherwise mask such information (if it has not been removed prior to being written into the workflow file itself).

By mimicking the application properties and workflow that is substantially indistinguishable, the above-described technique provides a convenient and efficient workflow recorder. It may be used with any desired tool to monitor and generate application-specific information, depending on the desired use case. By effectively simulating the original application, the playback functionality enables performance (perhaps by third party teams) of testing and tool development, as the user of the replay tool can interact with different components of the application as if they have access to the original application.

Preferably, each event is recorded and stored individually, and the associated event parameter data (such as evidenced in the XML examples above) is available to the replay tool components. Thus, the user performing the playback has fine-grained control over all aspects of the playback experience, as has been described.

As a further enhancement, users recording the workflow are afforded the option to add annotations to the recording, either in real-time during the recording, or anytime thereafter. Annotations may be desirable in that they may add useful information to the recording and be associated with different events, user interface elements or timestamps. During playback, the annotation can be presented to the user alongside the actual simulated interaction in such a way so as to provide further valuable data that cannot otherwise be captured by a simple recording. An example of an annotation may indicate the beginning of a bug workflow, or the highlighting of an important user interface element upon which the playback user should focus.

There is no requirement that the user or entity performing the recording is different or distinct from the user or entity performing the playback.

Although not meant to be limiting, preferably the event listener software module detects the desired events within the target application and then records the event type and its parameters (in a record file) for an application session. Preferably, event types are generic across applications. Representative event types include, without limitation, “text out,” “window created,” “button clicked,” “keyboard input,” and so forth. The associated parameters may also have generic attribute values. As described, preferably each event is time-stamped with its time of occurrence. If desired, an event may include other environment information including, without limitation, application name, path, window parameters (like size, style) and the like. FIG. 9 is a representative snippet of XML code that comprises part of a recording. The playback module (which may be an XML parser) reads the sequence of events from the recording file. Taking this example, when the playback module reads the “window_create” event, it creates a window with the same class name, width, height and other parameters as specified. The timestamp indicates when the event is to be performed (and this may be an absolute time, a relative time, or the like). The variable HWND is used to associate the window and events in the recording file. When the playback reads “Textoutput” event, it outputs the output text into the window with the correct HWND. Each event is processed in a similar manner to generate the clone of the application.

As has been described, after the recording is complete and the workflow capture file saved, a playback application is used to read the recording, reconstitute the application, simulate session behavior, and perform different actions (if needed) and analysis. The simulated application receives the same events as the original application, and it exhibits the same behavior and visuals. Events can be played back with the same timing of the original application, or the user can specify to pause on every or specific events, to play in a slower or faster speed relative to the original application, to jump to specific events, to jump to random events, or other such navigation operations.

The disclosed subject matter provides significant advantages. The technique provides the ability to mimic application properties and workflow in a way that it is indistinguishable for tools that want to monitor and generate application-specific information, such as SSO scripts, UI test-cases, and the like. The workflow capture file serves as an explicit specification document, which eliminates encumbering documents with screen captures, or maintaining and managing large video files that are difficult to search. Recording the application session as a series of semantic events (preferably described as text) allows for and/or facilitates annotation, searching, filtering, data mining, analysis, data compression, separation of user input and application behavior, and the like.

As the captured events can be adapted to cover many different types of user interface elements and their parameters, the simulated application can mimic effectively the original application, creating a clone of its layout, user interface hierarchy, and behavior in the recorded session. The simulated application can match the original application so closely that SSO profiles that interact directly with the user interface elements can be developed on the simulated application and then used with the actual application with no change.

The mimicking facility can be used by other tools that require application access, including from a remote location (such as an RFT expert sitting remotely can create test-cases around workflows captured by the development team). By using the approach, the captured data also can be used for auditing purposes, as such data includes the necessary information about the interaction of the user with the application. If deployed to monitor applications on a regular basis (e.g., as a system process), it can submit the user's interactions to a server where it can be stored for post-incidence analysis. Using the technique speeds up application deployment time, resulting in substantial reduction in time lost in obtaining access to the application and application credentials. For SSO enablement activities, the technique provides significant savings in the costs that might otherwise be incurred to obtain and analyze application-specific data and associated application credentials. This reduces the total cost of operation of the SSO product. The technique enables remotely-deployed experts to perform SSO enablement activities.

The described technique allows an SSO system to gather the necessary specification of the desired SSO behavior of an application in a way that does not require any immediate access to the application and its credentials by using a tool that captures the application workflow and properties and another tool which can mimic it offline.

The technique herein is much more lightweight than other recording solutions, such as video, as it does not require large amounts of memory associated with video recording and compression.

As noted, the functionality described above may be implemented as a standalone approach, e.g., a software-based function executed by a processor, or it may be available as a managed service (including as a web service via a REST or SOAP/XML interface). The particular hardware and software implementation details described herein are merely for illustrative purposes are not meant to limit the scope of the described subject matter.

More generally, computing devices within the context of the disclosed invention are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, SAML, Liberty, Shibboleth, OpenID, WS-Federation, Cardspace, WS-Trust, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures other than cloud-based infrastructures. These include, without limitation, simple n-tier architectures, web portals, federated systems, and the like.

As the above examples illustrate, one or more of the described functions may be hosted within or external to the cloud.

Still more generally, the subject matter described herein can take the form of an entirely hardware embodiment, an entirely software embodiment or an embodiment containing both hardware and software elements. In a preferred embodiment, the workflow recording and playback functions are implemented in software, which includes but is not limited to firmware, resident software, microcode, and the like. The data can be configured into a data structure (e.g., an array, a linked list, etc.) and stored in a data store, such as computer memory. Furthermore, as noted above, the recording and playback functionality described herein can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the recording and/or playback components are implemented in a special purpose computer, preferably in software executed by one or more processors. The associated application workflow file is stored in an associated data store. The software also is maintained in one or more data stores or memories associated with the one or more processors, and the software may be implemented as one or more computer programs.

The SSO function referenced herein may be implemented as an adjunct or extension to an existing identity provider, access manager or policy management solution. The described functionality may comprise a component of an SSO solution.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Any application or functionality described herein may be implemented as native code, by providing hooks into another application, by facilitating use of the mechanism as a plug-in, by linking to the mechanism, and the like.

Having described our invention, what we now claim is as follows:

1. A method of analyzing captured application workflow data, comprising:
receiving a data record that has been generated as a result of an interaction with an application, the data record being text-based and including application property data, and a time-based sequence of events representing the interaction;
using the data record to generate a clone of the application; and
re-playing the interaction with the application using the clone.

2. The method as described in claim 1 wherein the sequence of events includes at least a first event associated with an interface element of the application, and a second event associated with a user interaction with respect to the interface element.

3. The method as described in claim 2 wherein the interface element is a display window and the user interaction is an input associated with the display window.

4. The method as described in claim 1 wherein the data record is an XML file.

5. The method as described in claim 1 further including instrumenting the application to cause generation of the data record upon the interaction with the application.

6. The method as described in claim 1 further including annotating the data record to include additional information.

7. The method as described in claim 1 further including controlling a characteristic of the re-play.

8. The method as described in claim 1 further including masking sensitive information generated as a result of the interaction with an application.

9. Apparatus, comprising:
a processor;
computer memory holding computer program instructions that when executed by the processor perform a method for analyzing captured application workflow data, the method comprising:
receiving a data record that has been generated as a result of an interaction with an application, the data record being text-based and including application property data, and a time-based sequence of events representing the interaction;
using the data record to generate a clone of the application; and
re-playing the interaction with the application using the clone.

10. The apparatus as described in claim 9 wherein the sequence of events includes at least a first event associated with an interface element of the application, and a second event associated with a user interaction with respect to the interface element.

11. The apparatus as described in claim 10 wherein the interface element is a display window and the user interaction is an input associated with the display window.

12. The apparatus as described in claim 9 wherein the data record is an XML file.

13. The apparatus as described in claim 9 wherein the method further includes instrumenting the application to cause generation of the data record upon the interaction with the application.

14. The apparatus as described in claim 9 wherein the method further includes annotating the data record to include additional information.

15. The apparatus as described in claim 9 wherein the method further includes controlling a characteristic of the re-play.

16. The apparatus as described in claim 9 wherein the method further includes masking sensitive information generated as a result of the interaction with an application.

17. A computer program product in a computer readable medium for use in a data processing system, the computer program product holding computer program instructions which, when executed by the data processing system, perform a method for analyzing captured application workflow data, comprising:
receiving a data record that has been generated as a result of an interaction with an application, the data record being text-based and including application property data, and a time-based sequence of events representing the interaction;
using the data record to generate a clone of the application; and
re-playing the interaction with the application using the clone.

18. The computer program product as described in claim 17 wherein the sequence of events includes at least a first event associated with an interface element of the application, and a second event associated with a user interaction with respect to the interface element.

19. The computer program product as described in claim 18 wherein the interface element is a display window and the user interaction is an input associated with the display window.

20. The computer program product as described in claim 17 wherein the data record is an XML file.

21. The computer program product as described in claim 17 wherein the method further includes instrumenting the application to cause generation of the data record upon the interaction with the application.

22. The computer program product as described in claim 17 wherein the method further includes annotating the data record to include additional information.

23. The computer program product as described in claim 17 wherein the method further includes controlling a characteristic of the re-play.

24. The computer program product as described in claim 17 wherein the method further includes masking sensitive information generated as a result of the interaction with an application.

25. An article comprising a non-transitory tangible machine-readable medium that stores a program, the program being executable by a machine to perform a method for capturing application workflow data, the method comprising:
monitoring an interaction with a target application; and
generating a data record as a result of the interaction, the data record being text-based and including a representation of one or more user interface display screens, and a time-based sequence of events representing the interaction with respect to the one or more user interface display screens;
the data record being useable to generate a clone of the target application against which the interaction can be re-played.
